(19) United States
(12) Patent Application Publication
(10) Pub. No.: US 2011/0231353 A1
(43) Pub. Date: Sep. 22, 2011

(54) ARTIFICIAL INTELLIGENCE APPLICATION IN HUMAN MACHINE INTERFACE FOR ADVANCED INFORMATION PROCESSING AND TASK MANAGING

(76) Inventors: James Qingdong Wang, Duluth, GA (US); HongJhe Chen, Duluth, GA (US)

(21) Appl. No.: 12/726,016

(22) Filed: Mar. 17, 2010

(51) Int. Cl. G06Q 10/00; G06F 17/20; G06Q 50/00; G06N 5/02; G06F 17/00

(52) U.S. Cl. 706/45; 706/11; 706/54

(57) ABSTRACT

Methods and software provided for an AI application system that process user's needs through an intelligent user-system interface process. The user-system interface starts from user initial request, followed by system analysis to process with its algorithm, then question user to further clarify the request and refine it into specific request needs, details and categories, then collect, analyze and judge relative information, proceed to guide user find the most appropriate answer for the needs, together with other latest news and community/other users' feedback on this subject, and have the capabilities of assisting user executing the task needs. Thus greatly enhance the usability and efficiency of the artificial intelligence application to the world in information age.

### TECHNICAL FIELD

The present invention relates to unique artificial intelligence (AI) application in that through a specially designed user interface technology, the application system help users clarify, analyze, judge, make decisions on their needs such as sophisticated information, objectives to be fulfilled, tasks to be executed through AI interface communication, and help provide appropriate answers, approaches or procedures. The answers this application provides to users might be in the form of 1) more appropriate information, which will be hard for current search engine as they tend to produce tens if not hundreds of pages of links which might not be related to the sophisticated information been requested; 2) detailed and specific description of an objective user is contemplating, which was vague and incomplete when user initially indicates to system; 3) the detailed approaches/steps to execute the task and fulfill the objective; 4) the alert/reminding/scheduling of the implementation process regarding where, when, how to best implement the task needs; 5) related products, community or other information that users might find useful for their needs.

### BACKGROUND

Current AI application in usage is very limited. For example, the existing information processing like Google search was mostly built on ranking mechanism based from frequency of hits which lacks sophisticated AI logic, and tends to result in pages of links to websites containing the search word. In the time of information age where lots of users enter requests in complicated phrases or sentences, most of the resulted website links might not relate to users' specific needs.

On another example, if a user request is to fulfill an objective or execute a task, while only with vague idea, or clear idea but vague description, this user will mostly end up having nothing fulfilled.

Thus, a practical AI application that can 1) clarify the user's thoughts, 2) put the idea or objective into detailed specific terms, and 3) help users plan the tasks efficiently, prepare the approaches and process for fulfillment, and inform user related information and details . . . are mostly unavailable. The lack of these AI applications greatly affects the efficient functioning of the information age; even for information searching, users' unable to describe the complicated needs clearly tends to be a main cause for search engine's producing “Unable to Process” or irrelevant answers to the requests.

Current web application such as Google search enables user to search for a particular term—usually a single word, commonly noun. However, when users types in a long phrase or sentence as searching term, which might include noun, verb, time, location and other categories of information for the specific needs, Google is normally unable to process precisely, as a result tends to come out with unrelated information, or produce an answer “No results found for . . . ”, “Your search . . . did not match any documents”.

Other current web application with some basic AI logic such as: to buy a specific sports car with combination of specific advanced features, to plan a vacation overseas, to prepare applying for a school, to write a special document or report on a subject, user has to dig through sources and layers of information on web to proceed; if websites or sources are used improperly, then user might end up in frustration with no particular answer to the request needs.

It is obvious from the above examples that current AI application can't meet the needs of intelligent information processing and task fulfillment. In the situation that users don't express their intentions clearly, system can neither understand nor clarify with users the intended objective, rendering current application mostly unhelpful.

### SUMMARY OF THE INVENTION

As in some of above examples, current application require users to enter their request in terms that the application can recognize; while for any terms that the application can't recognize through its limited algorithm, or any terms that user did not define clearly, the application will be unable to process the request in a proper and intelligent way.

Thus an advanced intelligent application system is needed, where based on users' initial request input, and the continuous interface/communication (hint, question/answer for clarification, detailed categorizations, analysis.) between users and the system, the application runs through its intelligent algorithm to clarify the users' request, find the most appropriate answer for users, with plan on tasks execution and implementation for users to fulfill the request objective.

Embodiments of the present invention address these problems and others by providing unique intelligent interface between user and machine through a special AI dialogue system, and execute intelligent information processing for users' requests.
Based on the initial request input from users on their needs, the system will process by this intelligent dialogue to find appropriate answer for user;
in the case that the request is broad or vague, where users need to define/clarify it in detailed term; or there might be multiple categories of answers for the request, and the system needs more user input to provide the most appropriate answer—in the above cases the application system will proceed to ask user related questions to clarify the needs first, through which question/answer series, the application clarify user's request, and with the clarified answer further analyze/process the request needs based on its algorithm and information database.
if the user's answer to the above question leads to multiple choices to proceed further, and user is not sure which choice to select, system will make recommendation based on its analysis and judgment, helping users put their vague thoughts/intention into clear details for processing.

Overall, this application system produces relevant question to help users clarify their request objectives, supply suggestions or advice to guide user through the process, provide specific answer particular to user' needs, together with related task execution details and plan for the request fulfillment.

Specifically, some examples are illustrated in the following:

i.e., task manager: User has a vague idea on what need to be done ahead, while not clear on details, what are involved, how to execute to achieve the objectives,

i.e., intelligent calendar/personal assistant: User has a brief idea what needs to be done ahead, however not clear when and what is the best plan to implement them, what is the most efficient way for execution,

i.e., travel plan: User plans to travel to Italy, not sure what is the good season to fly there, which cities in Italy to visit, what historical, cultural, scenic or fashion places to see specific to user's interests, what hotels or renting house to stay, what need to bring for the trip, and want to know any tips from agencies/previous travelers on travelling there,

i.e., a purchase plan: User want to purchase a hybrid car, while not sure how to select in terms of the model, gas mileage, type of hybrid, battery, etc., and where to get it,

The embodiment of this invention contains the necessary algorithm to analyze the user input, compare the analysis result with categories of information in its database. Based on the analysis and comparison, the embodiment application system then asks user questions to further define (refine) the request; and from the answer user provides, the embodiment system will narrow down to the most appropriate solution to the request, and provide the answer to user, together with related implementation and execution details to fulfill the objective. The embodiment has the capability to think, collect information, analyze, judge, and provide result for users.

These and other advantages that characterize the present invention will be apparent from a reading of the following detailed description, and a review of the associated drawings.

### DESCRIPTION OF THE DRAWINGS

FIG. 1 shows an overall sketch of the inventions' typical interface application, with a view of the user—AI system interface relationship, where users enters their requests into the AI system, and through the intelligent interface, AI system process users' requests accordingly, which involves the dialogue communication with users to refine and clarify user requests, then analyze the clarified request, and produce the most appropriate answer for the requests, deliver to user the answer together with related details for planning and execution of the request objective.

FIG. 2 shows the invention application process flowchart, where after the system is initialized, users' request is entered as input, and the application proceeds to address the request and find the most appropriate answer as output. Description of the process with involving nodes as following:

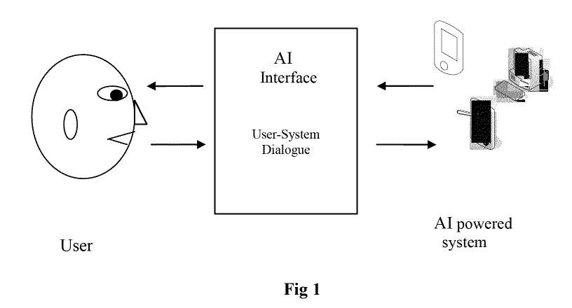

### Start—

A server in the network powers on and starts to run the program.

### Initialize Interface—

Initialize the server and enable network functionalities, load programs, language processor, and algorithms to server system memory.
Link programs to data repository.

### Input—

Machine (AI System) receives user's input as a stream,
The input is Human understood.
The input could be voice, images, alphabet, words, string, or various ways of human perception that can be translated into data.

### User—

One or various multiple human being who knows how to pronounce or present native speaking language or sign language, can use artificial perception, input varieties of data into interface system: computer or any AI processing devices.

### Output—

Feedback messages from AI system (program) to user, to clarify or refine the request for processing, or after processing provide final answer information to user, together with necessary task execution/implementation plans for the request fulfillment. The message could be text, sound, images, a perception signal feedback, or any kind of information that Human understands.

### Language Understanding—

This stage aims to comprehend human input stream, process the language validation procedure, parse the language structure, and identify the language type.
The stage builds language information that's related to the input stream.

### Is an Ambiguous Sentence—

Ambiguous sentence means the input stream can't be comprehended by grammatical processor.
If the input stream is an ambiguous sentence, the input stream might be noise (composed with non-meaning alphabet or words), non-grammatical alignment, or unknowable data.

### Hash the Input Stream—

This stage aims to process non-grammatical alignment input stream or locate the scattered meaning words from the input stream, and process it into system recognizable signal.
As for the noise, non-Human readable data, or unknown data which could not be re-described into machine understanding form, it normally still passes through next process. The stage uses a hash method to handle the input stream.
The hash method here functions like jigsaw puzzle game, that it dumps the stream to a language network (software algorithm, different from computer network). The network records the meaning words with property hierarchy rather than the grammatical rule. The network is an arbiter, where it decides which meaning of word is picked from internal database and filled to the machine understanding form.

### Extract Meaning—

This stage aims to process grammatical input stream, and re-describes the input stream into a machine understanding form.

### Is an Answer—

An answer here is the input stream reply of the question which machine issued on the last full program cycle (a full program cycle means the program starts from the input, process the input stream, issue a response, then end on the output).
If the input stream is an answer, redirect this program cycle with the input stream and parsing information to the answer handler.

### Found Subject—

In case an answer is not found in the last stage, system will find the subject first. The subject means an absolute target of noun. For example,
Infer a Subject and Confirm the Subject with User—

In the case that a proper subject is not found through the algorithm, system will try refer a related subject to user to obtain feedback and confirmation whether it is a correct subject.

### Is Sentence Executable—

In the case that the proper sentence and subject is found, system will then explore whether the sentence is executable based on current available structure.

### Reports Related Resources to Get Users' Feedback on Execution—

In the case the sentence is not executable in the above stage, system will report to user some related resources on this to user for feedback on the execution methods suggested

### Satisfied to Execute—

The proper sentence is satisfied and requirement met for system to execute further for an answer.

### Fetch Next Query—

In the case the sentence is not satisfied and requirement not met for the system to execute in the above stage, system will fetch the next query for user to go through the execution process again to find the proper sentence.

### Execute—

The proper sentence and subject is obtained through the above process, and the system goes through the AI application process, which includes: collect related information, analyze, judge on the most appropriate answer/solution/execution.
FIG. 3 shows the software architecture of the process, which consists of different layers based on their functionalities: 1) The top layer is the input layer, where the objective is initiated, 2) then followed by the user layer, where the objective needs is passed on from user to system as initial input, in the form of a clause or sentence. 3) This is then followed by the user-AI system interface layer and AI system layer, where AI system analyzes users' initial request, ask user questions to clarify the objectives, and with a further question-answer dialogue session here, system has the users' request objective clarified properly into detailed terms. 4) Then it is the AI application processing layer, the center of AI processing, where system collect, analyze the information, and process it catering to users' request. Once system achieves final answer to the request, this final answer will be passed on from system to user as final output to meet users' needs;

### DETAILED DESCRIPTION

Embodiments described herein facilitate the artificial intelligence application in processing complicated task requests, such as event calendar planning, research report preparation, hybrid sports car sourcing, an African vacation planning, etc, where users unclear on details/specifics that are related to the vague objectives, or neglect to express the objectives clearly, resulting in the topic too broad for current IT mechanism to process. With the embodiment application, information can be processed properly to meet users' requests.

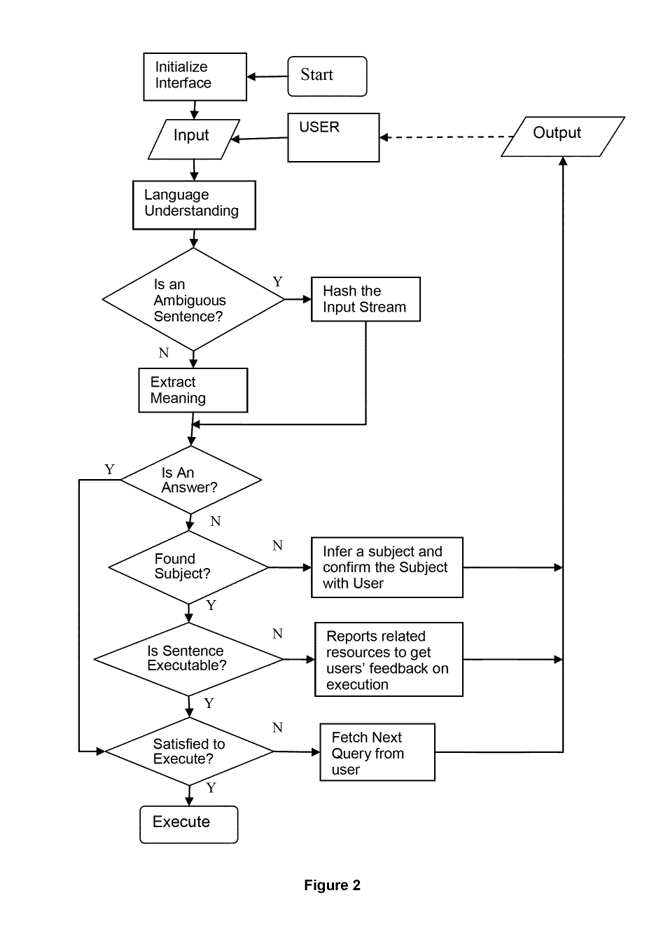

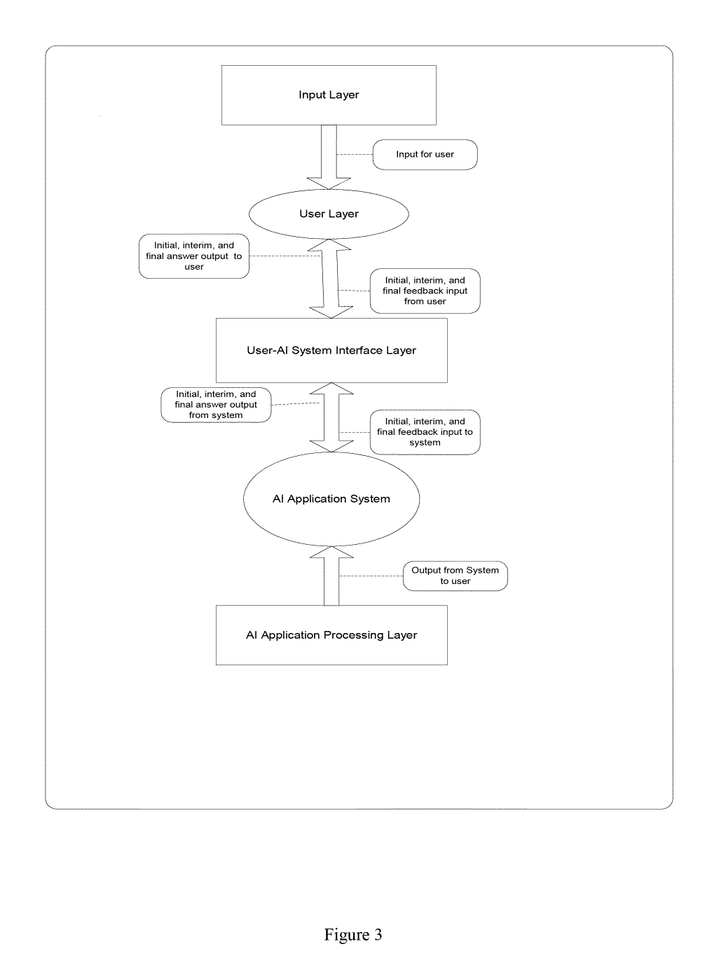

In the following detailed description, references are made to the accompanying drawing FIG. 2 that form a part hereof, and in which are shown by illustrating specific embodiments or examples. The inquiring user is referred to as “user” for simplicity, the AI application system that user interface with which process the application here is referred to as “system” for simplicity. The main steps are shown in the figures as a “white box” or a “block”, the decisions in the procedure that system makes is shown as a “diamond”. The following are four example dialogues for FIG. 2 application, which is between the user and system on specific task processing; all the four examples may contain complex words or phrase, plural or singular nouns.

Example 1: want to (Buy a Car).
Response: What is the brand you want to buy?
The example assumes car is a subject, and a property of brand belongs to the subject.
Example 2: I want to (Buy a 350i).
Response: Do you want to purchase a Hawker Beechcraft King Air 350i, or a Sony Ericsson 350i, or a BMW 350i car?
If the user's answer to this is BMW 350i, the system assumes 350i belong to a brand of BMW, and BMW belong to car.
If it's a positive answer then continue to example 1. If it's a negative answer then process the input string.

### Example 3: I Expect to (Buy a Car).

Response: When will you buy a car? (How soon?)
If the answer replies to above Response then continue to example 1. If the answer is not a feedback then process the input string.
Example 4: I want to (buy a car quickly/make a quick purchase on vehicle).
Response: Do want to buy a car online (which is quicker)?
If the answer replies to above Response then continue to example 1. If the answer is not a feedback then process the input string.
The following is the above Example 1 process in detail:
The AI system is on and the AI server is initialized, with the programs and language processor loaded.
The user enter input—buy a car, and system receives user's input as a stream.
User here is the human being that has needs which in this case is “to buy a car” and express it to the system.
System will now proceed to understand the language of user request, process the language validation procedure, parse the language structure, and identify the language type.
Based on its algorithm, system decides the input request is an ambiguous request, and to clarify, it will hash the input stream, to see whether a correct answer (or meaning) of the request can be found, which in this case is not.
Then system will proceed to find a subject, which is to infer a subject to user for confirmation based on its analysis—“so you want to buy a car?”, this output passed on to user, user enter input answer “Yes, I want to buy a car”.
The system then process from the beginning again, until the same node of “find subject”.
As the subject is still not clear, system will then proceed to infer a subject to user as output “what brand of car you want to buy?”, and user input answer “Beaver”.
System will then process from beginning again, until the same node of “find subject”.
As the subject is clear now, system will then proceed to the next node to see whether executable or not, in this case not executable as it seems user want to buy a beaver, but it is not the original request of “to buy a car”. System will then report related resource to user to get feedback, which in this case is output to user as “do you want to buy a Beemer, not a Beaver, is that what you mean?”, and user input answer “yes I want to buy a Beemer.”
System will then process from beginning again, until the same node of “is the sentence executable”, in this case to execute system needs to clarify with user whether a BMW is referred as the purchase subject here. System will then report related resource to user to get feedback, which in this case is output to user as “do you want to buy a BMW, is that what you mean?”, and user input answer “yes I want to buy a BMW, a BMW Beemer.”
System then process from beginning again, until the same node of “is it executable”,
in this case it's executable now, system will then proceed to next node whether “it is satisfied to execute”, which in this case system still has unanswered questions to clarify with user for execution.
System will then fetch next query to user to get feedback, which in this case is output to user as “what year, model, color, price range, or other specific features do you want for this BMW?”, and user input answer “red color, BMW M3 or latest version Coupe, around 60K, V8, fully loaded, prefer with GPS, voice activation/control, and any possibility of a hybrid”
System then process from beginning again, until the same node of “satisfied to execute”.
As the subject is satisfied to execute now, system will then proceed for execution based on its algorithm, analysis, database information, ending with system make judgment for user to pick the most appropriate sports car here.
By this way the user input—“I want to buy a car” was run through this process, and through AI dialogue the system figures out the brand, the model, the year, the price range, and any specific feature user want for the car to purchase, and run through the database to find the appropriate car for user, and plan the purchase procedure.

What is claimed is:

1. Artificial Intelligent applications, where an objective input (input layer) arising from idea, intention or thought passed on from users' (user layer) brain to hand or voice to be entered into the system as user initial input, is processed through artificial intelligent user-machine (system) interface or dialogue, resulting in sophisticated and intelligent task processing, which comprising:
The user-AI system interface layer, where from user initial input, AI system analyzes users request, ask user questions to clarify the objectives/needs, and with user feedback proceed on further analysis, and examine whether the request objective is clear with enough details to proceed. Otherwise user and system will go through a further question-answer dialogue session, so in the end system has the user's request objective clarified with specific related information;
AI application processing layer, where system collects related information from its database and Internet, and process the information catering to user's request needs, make analysis and judgment for user. After system achieve final result for user request based on the processing, this final result will be delivered from system to user as final output to user, helping user reach the objective of the request;
An application as described in claim 1 that process user's vague request into detailed, categorized and specific request through user-system intelligent interface; and execute the request through an AI process; produce the appropriate result for user and suggest task execution methodology;
An application as described in claim 1 that runs intelligent information searching and mining for complicated phrases or sentences through the above process, providing users the most appropriate information for sophisticated needs;
An application as described in claim 3 that runs user purchase needs, collect, analyze and judge relative information, then study and find the most appropriate product for user based on input request, or information for their specific product needs through above process;
An application as described in claim 2 that clarify user's thoughts input, which could be in the form of voice, images, alphabet, words, string, or various ways of human perception that can be translated into data, and think on user's behalf to produce clarified, concrete and specific request objectives through above process;
An application as described in claim 3 that clarify users' input needs on a task execution, then collect, analyze and judge relative information, process the needs and suggest or assist users execute the needed tasks through above process;
An application as described in claim 3 that based on user initial input, clarify, collect, analyze and judge relative agenda information, and prepare an optimized calendar with details for user based input request.
An application as described in claim 3 that based on input needs of users from different industry such medical, law enforcement, transportation, etc., the application clarify, collect, analyze and judge relative information in the related industry, such as medical terms, medical records, medicine information . . . , criminal law information, criminal records . . . , the toxicity and characteristics of products needs to be shipped, . . . , etc., and provide the appropriate information and suggestion to user for the particular needs of the field, and help users execute tasks in the field efficiently;
An application as described in claim 3 that help users with creative work, where the application clarify the users' needs of creative work in particular field, then collect, analyze and judge relative information in the field, produce the possible relevant creations based on the data collected and analyzed, and judged the appropriate creation for the user particular to the user's circumstances, and present to user, together with assist user in the execution of the creation;
An application as described in claim 3 that clarify users' inquiry needs including on product, market, industry, country, region, religion, events, etc., the application then collect, analyze and judge relative historical, current information, and present to users the appropriate information in a report or other forms which may cover inquiry subject's past, present, and future forecast;
An application as described in claim 3 that help users clarify their thoughts, then collect, analyze and judge relative information, and help efficiently and economically plan a trip or vacation, custom build a product, sell a product, buy a product, etc. through the above intelligent process;
An application as described in claim 3 that help users clarify their needs, then collect, analyze and judge relative information, and help user create documentation, proposals, memos, reports, plans, schedules, to-do list, etc. through the above process;
An application as described in claim 3 that help users clarify their business needs input, then collect, analyze and judge relative information, and prepare business plan, strategy, execution roadmap, development plan, procedures, strategies, rules, timetables, testing plan, marketing plan, financial plan, growth plan, merger and acquisition plan, etc. and help users execute related business task through the above process;
An application as described in claim 3 that help users clarify their personal request needs, then collect, analyze and judge relative information, and prepare personal plan, strategy, procedures, rules, fulfillment roadmap, personal timetable, growth plan, financial plan, etc. and help users execute related personal task through the above process;
An application as described in claim 3 that based on historical and previous user information, analyze users' habits and styles, collect, judge relative information, and make plans, suggestions, proposals, timetables, etc. to user for their future tasks through the above process;
An application as described in claim 3 that enables any website to have a smart user—system information processing window, where users can input their thoughts, needs or questions to the website system, and through the intelligent interface communication, system analyze, judge and provide users the appropriate answer quickly through the above process, without resorting to website human customer support;
An application as described in claim 3 that enables intelligent processing in user interface terminals at public facilities (libraries, banks, community centers, museums, etc.) such as a user question/service monitor, or a customer self service LCD screen/speaker, where users can input their thoughts, needs or questions to the system, and through the intelligent interface communication, the system analyze, judge and provide users the appropriate answer quickly through the above process, based on the information in the facility database;
An application as described in claim 3 that enables intelligent user interface applications on mobile devices such as cell phones, smart handheld dives (PDAs, iPODs, iPADs, etc.), GPS, and other mobile electronic appliance devices, where through the above artificial intelligence process running in the unit either from backend server or embedded at devices, users can input their requests, needs or questions to the mobile device system, and through the intelligent interface communication, the system analyze, judge and provide users the appropriate answer quickly, enabling instant and efficient service to user through devices;
